(19) United States
(12) Patent Application Publication
(10) Pub. No.: US 2010/0332629 A1
(43) Pub. Date: Dec. 30, 2010

(54) SECURE CUSTOM APPLICATION CLOUD COMPUTING ARCHITECTURE

(76) Inventors: Lauren Ann Cotugno, Dove Canyon, CA (US); Margaret Lustig, Topsfield, MA (US); Scott Costello, White Bear Lake, MN (US)

Correspondence Address: UNISYS CORPORATION;Office of the General Counsel, 801 Lakeview Drive, Suite 100, MailStop: 2NW, BLUE BELL, PA, 19422, US

(21) Appl. No.: 12/644,095

(22) Filed: Dec. 22, 2009

Related U.S. Application Data
(63) Continuation of application No. 12/525,848.
(60) Provisional application No. 61/220,045, filed on Jun. 24, 2009.
(60) Provisional application No. 61/220,827, filed on Jun. 26, 2009.

(51) Int. Cl. G06F 15/173; H04L 9/00; G06F 15/177

(52) U.S. Cl. 709/221; 713/153; 709/226

(57) ABSTRACT

A secure custom application cloud computing architecture which facilitates virtually seamless migration of custom applications to and from a cloud computing environment in response to user needs. The architecture identifies the custom applications and the associated network architecture needed to support the applications. The network architecture is then replicated in the cloud and the custom applications are migrated thereto. In some embodiments, the application can be archived while in the cloud and disabled, then later reenabled when needed.

This application claims the benefit of Provisional U.S. Patent Application Ser. No. 61/220,045, filed Jun. 24, 2009, Provisional U.S. Patent Application Ser. No. 61/220,827, filed Jun. 26, 2009, and Provisional U.S. Patent Application Ser. No. 61/229,989, filed Jun. 30, 2009, each of which are incorporated by reference herein in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to the field of secure computing architectures, and is more specifically directed to a cloud computing architecture which facilitates the deployment of a custom multi-tiered application.

### BACKGROUND

Cloud computing is a term that has been used for some time, and generally refers to the concept of outsourcing data storage or computational needs to a third party who provides all of the necessary infrastructure without the need for the user to even be aware of who is providing the services or where the services are performed (i.e., the services are performed “in the Internet cloud”). More specifically, cloud computing can be seen as a style of computing in which massively scalable information technology resources are delivered as a service to one or multiple customers, typically using Internet technologies, and typically from an off-premises location relative to the location of the consumers of the service. In cloud computing, elastically scalable resources are dynamically distributed and redistributed on demand, frequently in metered quantity and quality.

Cloud computing is generally seen as consisting of different types of services, for example software as a service (“SAAS”), platform as a service (“PAAS”), and infrastructure as a service (“IAAS”). SAAS is a model of software deployment in which software is provided as an on-demand service. FIG. 1 illustrates an exemplary SAAS environment. In SAAS, users pay a relatively low fee, on a recurring basis, to access and use the software, rather than facing what can be significant up-front licensing costs associated with traditional software licensing models. Users typically access the software from their desktop, laptop, or other computing device 110, which is connected to Internet 130 via router 120. In some instances, the software is accessed by the user opening a browser or other software application and entering a Uniform Resource Locator (“URL”) into the browser. The browser interprets the URL and sends the associated request to one of interface/web servers 140 via Internet 130. The interface server receives the request and obtains the requested software from back-end server 150 and/or database 160. In some cases, the software is then loaded by interface server 140 for presentation to the user via the browser, with most of the processing occurring on interface server 140. In other cases, the software, or portions thereof, is transferred to computing device 110 for execution by the computing device. SAAS has the advantage of allowing the user to access the most recent version of the software, including any patches, enhancements, and the like, each time the software is used and from any location on any computer. This is in contrast to the traditional software distribution model in which the user licenses access to a specific version of the software for use on a particular computer.

Unlike SAAS, in which the user simply licenses access to the basic software, in PAAS the user leases access to an entire platform. Such platforms are typically built around a core set of functionality (e.g., customer resource management) and frequently are designed to enable team collaboration, web service and database integration, and the like. PAAS is typically seen as being advantageous because common problems such as scalability, storage, persistence, state management, application versioning and instrumentation, database integration, and the like are handled behind the scenes by the PAAS provider. FIG. 2 illustrates an exemplary PAAS architecture in which interface/web server 240, middleware server 250, back-end server 260, and database 270 are typically housed remotely from user computers 210 and are accessed via Internet 230. Generally, user computing devices 210 are part of a corporation or other group, and access Internet 230 via one or more routers 220. The platform can be accessed by running a browser or other software on the computing device 210. An Example of PAAS is the well known Google App Engine platform provided by Google, Inc. of Mountain View, Calif.

In IAAS, the user leases access to certain infrastructure (e.g., a physical or virtual server with particular computational and/or storage capabilities). This gives the user the flexibility to set specific requirements about how the infrastructure is configured, and allows them to narrowly tailor the operation of their leased system. FIG. 3 illustrates an exemplary IAAS architecture. By way of example, without limitation, a financial services organization may lease a high-performance, high availability server 340 and pay based on the number of instructions executed per second by the server (e.g., “MIPS”, or millions of instructions per second, based billing) in response to inquiries received from computing devices 310, which are connected to Internet 330 via router 320. This can allow the organization's users to leverage the increased computing power of a high-performance server while only paying the higher rates associated therewith at times of peak demand (e.g., end of month reconciliation). IAAS is generally advantageous for business that wish to decrease their internal IT costs by renting or subscribing for services to deliver the infrastructure they require, while still having access to state-of-the-art systems, and where the start-up costs associated with building the necessary infrastructure would otherwise be cost prohibitive. In another example, a user that is responsible for maintaining an complex application for a company that only uses it seasonally, or based on schedule (quarterly, for example) can use IAAS to bring up additional servers during times of peak demand, thereby distributing the demand across additional servers and improving overall responsiveness. For example, a large shopping web site might request that the IAAS provider bring up additional servers during Christmas to help improve their customers' experience, and shut those servers down when demand subsides.

Cloud computing is likely to be appealing to new companies that have few legacy investments to protect, thus enabling them to build their business around the newer technologies. Similarly, new projects within existing companies (e.g., research and development, testing, etc.) can benefit from cloud computing because they can gain access to significant computing resources for relatively modest start-up costs. Cloud computing is also appealing to traditional businesses a they look to stem information technology related capital expenditures when their servers go end of life.

### SUMMARY

Unlike new businesses and new projects within existing businesses, many current users are reluctant to move their businesses into the cloud because doing so would involve transferring control of applications and data, including potentially sensitive data (e.g. healthcare records, customer lists, current research and development project information, etc.) to a third party. Such transfers may not only pose business risks, they may also run afoul of certain legal requirements. One proposed solution to this problem is a “hybrid cloud”, in which certain cloud-like functionality is performed within the user's network infrastructure while other such functionality is performed “in the cloud”, thus enabling the user to exercise the desired level of control over their applications and data while still allowing the user to utilize of some of the advantages of cloud computing. Such a model will allow businesses to utilize public or external cloud solutions for their conventional or legacy/back office business applications thus freeing up critical information technology resources within their own network for mission critical workloads and data processing.

While hybrid clouds appear to be a good solution to the cloud computing dilemma for these established companies, hybrid clouds have not been readily adopted by those in the industry. One reason for this slow adoption is that the current cloud computing offerings are typically seen as requiring an “all or nothing” approach to implementation. That is, users evaluate what software, platforms, and infrastructure can be moved into the cloud with the expectation that such software, platforms, and infrastructure will permanently stay in the cloud.

Another reason hybrid clouds have been slow to catch on is that many businesses rely on complex custom or semi-custom applications, and many such applications require multi-tier architectures for them to function properly. By way of example, without limitation, a user may be willing to move certain software into a SAAS model because, when used, that software is used in it's “off the shelf” form. For example, a law firm that wishes to make computer aided drafting (“CAD”) software available to its employees such that they can utilize the software on the rare occasions that software is actually needed may find it significantly more cost effective to make such software available under a SAAS model, rather than buying licenses for each of the firm's employees. Since the employees will most likely want the standard version of the CAD software, a SAAS model makes a lot of sense.

By contrast, many current businesses rely on highly customized, or custom written, applications for their operations. Examples of such applications can include, without limitation, accounting and payroll systems, human resource records, time and attendance applications, document management systems, claims processing, client statement processing, and the like. In many cases, these applications are used enterprise-wide, and frequently are implemented using an “n-tier” architecture. These factors make it much less appealing to consider moving such applications “into the cloud”. By way of example, without limitation, while an n-tier architecture can be implemented in an IAAS environment, current technology requires that each server in the each tier be brought online and configured individually. This is contrary to the general notion of “hands-free” configuration that is typically associated with the cloud, thus making cloud-based n-tier architectures less desirable for custom environments. In addition, to take advantage of the particular cloud computing providers' platform or infrastructure, a custom application must be retooled to operate within the guidelines established by that provider. The costs associated with such migration can be significant, and thus many companies are not moving their applications into the cloud.

What is needed is a network architecture, and related systems and methods, which allow businesses employing custom applications and/or complex architectures to leverage cloud-based computing. Accordingly, the instant disclosure is directed to a secure custom application cloud computing architecture that substantially obviates one or more of the problems due to limitations and disadvantages of the related art.

Features and advantages will be set forth in the description which follows, and in part will be apparent from this disclosure, or may be learned by practice of the disclosed secure custom application cloud computing architecture. The objectives and other advantages of the secure custom application cloud computing architecture will be realized and attained by the structure particularly pointed out in this written description, including any claims contained herein and the appended drawings.

It is to be understood that both the foregoing general description and the following detailed description are exemplary and explanatory and are intended to provide further explanation of the disclosed secure custom application cloud computing architecture.

### BRIEF DESCRIPTION OF THE DRAWINGS

The accompanying drawings, which are included to provide a further understanding of the disclosed secure custom application cloud computing architecture and are incorporated in and constitute a part of this specification, illustrate various embodiments and, together with the description, serve to explain the principles of at least one embodiment of the disclosed secure custom application cloud computing architecture.

In the drawings:

FIG. 1 is a block diagram illustrating a conventional SAAS architecture.

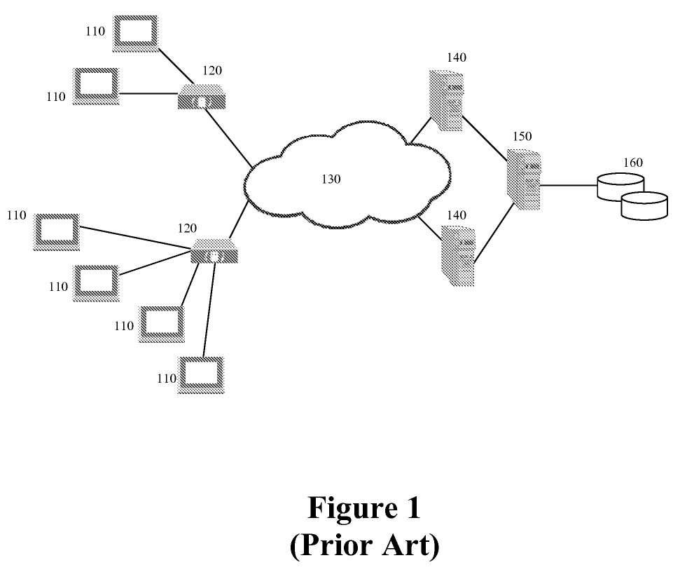

FIG. 2 is a block diagram illustrating a conventional PAAS architecture.

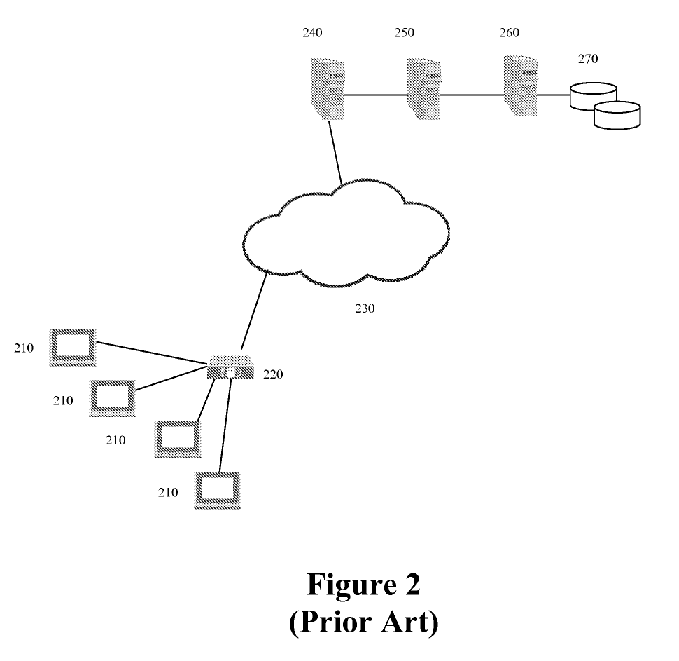

FIG. 3 is a block diagram illustrating a conventional IAAS architecture.

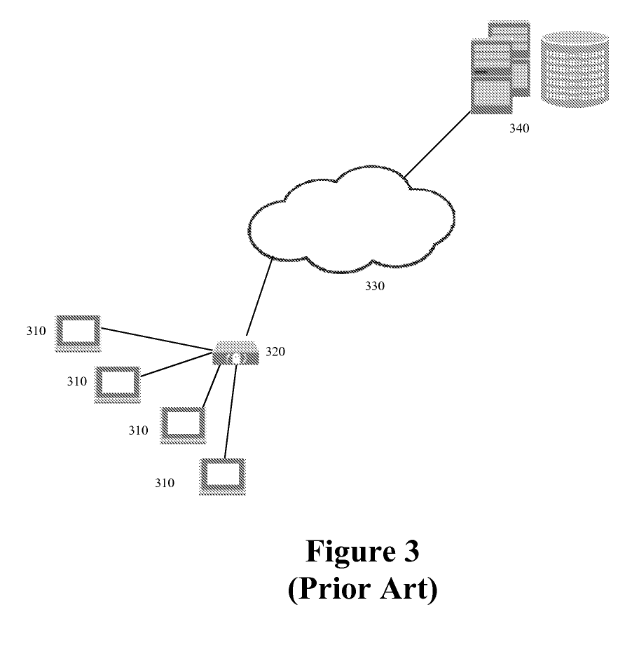

FIG. 4 is a flow chart illustrating an exemplary provisioning logic flow which can be supported by the disclosed architecture.

FIG. 5 is a block diagram illustrating an exemplary architecture prior to the receipt of a provisioning request.

FIG. 6 is a block diagram illustrating an exemplary architecture after a provisioning request capable of being supported by a virtual machine is received.

FIG. 7 is a block diagram illustrating an exemplary architecture before a provisioning request capable of being supported by a physical machine is received.

FIG. 8 is a block diagram illustrating an exemplary architecture when a physical machine provisioning request is being fulfilled.

FIG. 9 is a block diagram illustrating an exemplary user network architecture.

FIG. 10 is a block diagram illustrating the exemplary architecture of FIG. 9 after a portion thereof has been migrated to cloud resources.

### DETAILED DESCRIPTION

Reference will now be made in detail to embodiments of the disclosed secure custom application cloud computing architecture, examples of which are illustrated in the accompanying drawings.

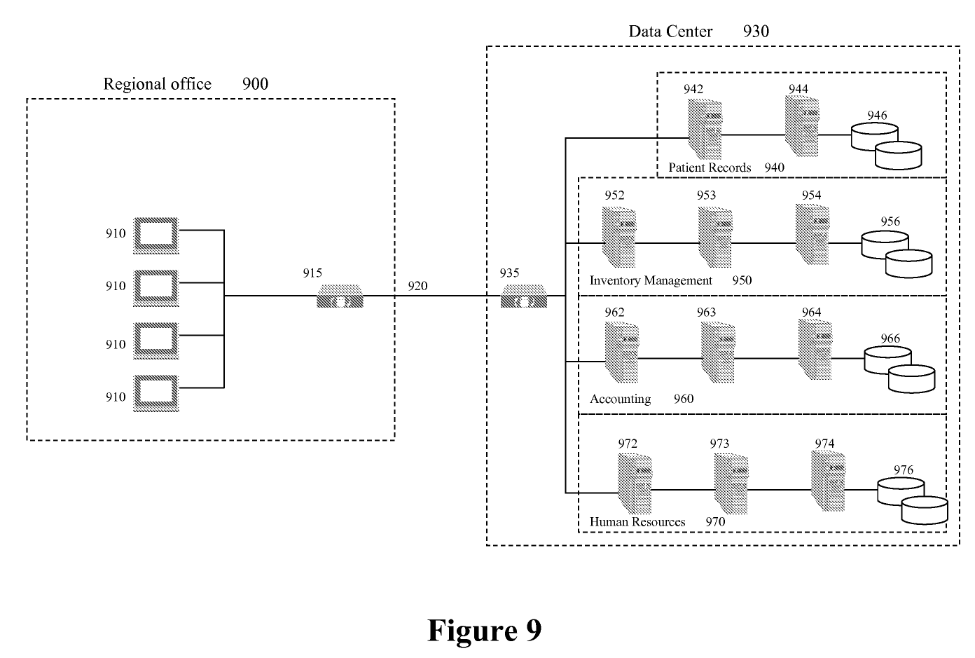

As described above, many businesses are not able to take advantage of cloud computing because of the complexities of their system. By way of example, without limitation, these businesses may rely on custom applications which require an extensive architecture to implement. FIG. 9 is a block diagram illustrating a network architecture, and the various components thereof, that could be utilized by a hypothetical hospital or other such business. Because a hospital requires high availability of a variety of information, including, without limitation, patient records, inventory management data, accounting data, human resources data, and the like, the information can be housed, and access thereto provided via, a data center 930. In some embodiments, data center 900 may be geographically proximate to a regional office 900 which provides services to patients, although such proximity may not be necessary. Although the instant architecture and related systems and methods are illustrated as depending on data center 900, it should be apparent to one skilled in the art that the computing systems within data center 900 need not actually be deployed within a true data center, and that any private computing environment may be substituted therefor without departing from the spirit or the scope of the invention.

In the exemplary architecture illustrated in FIG. 9, computing devices 910 have client software running thereon which allows the respective computing devices to access the information provided from data center 930. Such client software may include, without limitation, one or more custom applications, a web browser, and/or custom software that runs within the web browser (e.g., a plug-in, add-on, extension, or the like). Such client software may be written in one or more computer interpretable languages, including, without limitation, JAVA, C++, C#, and AJAX.

The client software typically accesses data center 930 via a private communications link 920. In some embodiments, private communications link 920 may be a dedicated, high-speed connection, dial-up connection, virtual private network connection, or the like. Router 915 can facilitate communications between a private network shared by computing devices 910 and data center 930. Within data center 930, router 935 facilitates communications between the private network deployed within data center 930 and private communications link 920.

In the exemplary embodiment illustrated in FIG. 9, access to patient records is provided via patient records system 940. Patient records interface server 942 provides the logic necessary to perform requisite functions, such as, without limitation, applying business process rules to the data that is entered via an appropriate client application running on one or more of computing devices 910. Patient records database server 944 facilitates access to patient records database 946. Patient records database server 944 can receive database-related queries from patient records interface server 940, search and/or update patient records database 946, and return the results to patient records interface server 940. Patient records interface server 940 can provide the returned information, or a subset thereof, to client software running on one of the user computing devices 910.

Inventory management system 950 facilitates access to inventory information such as, without limitation, the number of hospital gowns, bandages, crutches, and prescription and non-prescription drugs currently in stock. In the illustrated embodiment, inventory management web server 952 provides an HTML and/or JAVA-based interface to the inventory management system. A user simply launches a web browser on one of computing devices 910 and enters an appropriate Uniform Resource Locator (“URL”) to access the inventory management system. In the illustrated embodiment, inventory management web server 952 comprises a server computer having one or more microprocessors, on which the Windows Server 2008 operating system, distributed by Microsoft Corporation, is running. Inventory management web server 952 may also have Internet Information Service (“IIS”) running within the operating system to facilitate providing the web server functionality. Inventory management web server 952 may comprise one or more custom pages written in Hypertext Markup Language (“HTML”), eXtensible Markup Language (“XML”) or the like, as well as scripts, applets, and the like, which are used to customize the performance and/or interfaces provided by inventory management web server 952.

In the illustrated embodiment, inventory management middleware server 953 receives user instructions, queries, or other requests from inventory management web server 952 and is responsible for generating reports, applying business logic, and the like based on the received requests. In the illustrated embodiment, inventory management middleware server 953 comprises a server computer having one or more microprocessors, on which the Windows Server 2008 operating system, distributed by Microsoft Corporation, is running. Inventory management web server 952 may also have one or more applications running within the operating system which facilitate interfacing between inventory management web server 952 and inventory management database server 954. Such applications may be completely stand-alone, or may make use of one or more static and/or dynamic link libraries (“DLL's”) of computer code.

Inventory management database server 954 facilitates access to inventory management database 956, including performing queries against the data stored in inventory management database 956, and adding, updating, and/or removing records from inventory management database 956, and the like. In the illustrated embodiment, inventory management database server 954 comprises a server computer having one or more microprocessors, on which the Windows Server 2008 operating system, distributed by Microsoft Corporation, is running. Inventory management database server 954 may also have SQL Server, distributed by Microsoft Corporation, running within the operating system. SQL Server is a well known database server that facilitates storing information in one or more relational databases, as well as retrieving and modifying the stored information. In some embodiments, complex and/or frequently used queries or other customizations may be stored in database server 954 and/or inventory management database 956.

Although inventory management system 950 is described above as comprising computing systems and a network architecture built around the Windows Server 2008 operating system and software written therefor, it should be apparent to one skilled in the art that alternative operating systems and/or software can be substituted therefor without departing from the spirit or the scope of the disclosed secure custom application cloud computing architecture. By way of example, without limitation, one or more of the servers that make up inventory management system 950 may run one of the several Linux operating system variants that exist, with software running therein that is analogous to the software running in the Windows Server 2008 operating system described above.

In the embodiment illustrated in FIG. 9, accounting system 960 utilizes an architecture similar to that of inventory management system 950, with accounting web server 962 being substituted for inventory management web server 952, accounting middleware server 963 being substituted for inventory management middleware server 953, accounting database server 964 being substituted for inventory management database server 954, and accounting database 966 being substituted for inventory management database 956. Similarly, human resources system 970 utilizes an architecture similar to that of inventory management system 950, with human resources web server 972 being substituted for inventory management web server 952, human resources middleware server 973 being substituted for inventory management middleware server 953, human resources database server 974 being substituted for inventory management database server 954, and human resources database 976 being substituted for inventory management database 956.

It should be noted that FIG. 9 illustrates the communications between Regional Office 900 and data center 930 as occurring through a single router and a single private communications link for simplicity of explanation. In many actual embodiments, a plurality of routers and communications links would likely be employed to reduce the likelihood of single point source failures and to enhance redundancy, and such embodiments are intended to be part of the instant disclosure. Similarly, while private communications link 920 is described above as a private and/or secure communications link, the Internet can be substituted therefor without departing from the spirit or the scope of the instant disclosure.

It should also be noted that while FIG. 9 illustrates certain functions as being performed by a single server per system, and a fixed number of servers per system, this is done purely for simplicity of explanation and is not intended to limit the disclosure to only those functions and numbers of servers. By way of example, without limitation, the functions provided by one server described above may in fact be provided by a plurality of servers functioning as part of a cluster. Similarly, although the various systems provided by data center 930 are illustrated as employing an n-tier architecture, alternative architectures may be substituted therefor without departing from the spirit or the scope of the disclosure.

In the exemplary embodiment illustrated in FIG. 9, the hospital may need to run quarterly reports or perform other complex accounting tasks periodically. While such tasks can be performed using the existing systems, such tasks are typically resource intensive and require significant Central Processing Unit (“CPU”) time, memory, and/or input/output (“I/O”) operations, and may require locking of one or more records within accounting database 966. Thus, these tasks are frequently performed during evenings or other periods of reduced system utilization demand. Unfortunately, when errors occur or changes are needed, the tasks must be re-run, and depending on the urgency of the need for the information, they may need to be performed during higher demand periods.

One solution is to bring online additional resources within Data Center 930 to help address the computational needs. However, doing so requires the purchase of the resources which would otherwise be idle or underutilized except during such relatively rare times that the complex tasks are performed. This is not a cost-effective solution for many businesses, and thus the businesses will not invest in such resources.

In addition, given the privacy and security associated with much of the exemplary hospital's data, it is not desirable to push such data out to the cloud. For example, the accounting information described above would inherently include personal information about each patients' treatment, the costs, their insurance company, and the like. Thus, the exemplary hospital would not be able to move the accounting system into the cloud. Because the system cannot be pushed into the cloud, the exemplary hospital would not be able to leverage conventional cloud computing's ability to dynamically bring in new resources to meet the accounting system's demands.

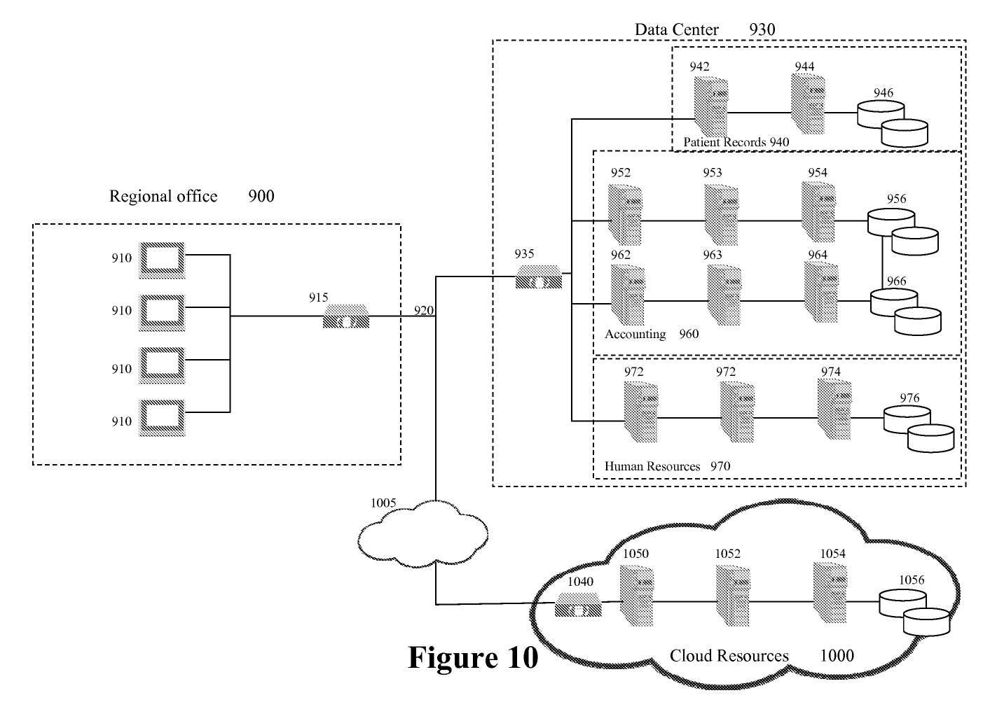

By contrast, the instant disclosure is directed to a secure custom application cloud computing architecture through which some systems provided by data center 930 can be temporarily moved into the cloud, thereby freeing resources within data center 930 to assist with the accounting demand. By way of example, without limitation, FIG. 10 illustrates temporarily moving the inventory management system 950 into cloud resources 1000, thereby freeing web server 952, middleware server 953, database server 954, and/or database 956 to help meet the accounting system's demands.

In the embodiment illustrated in FIG. 10, when a user attempts to access the inventory management system via computing device 910, router 915 dynamically routes the request to router 1040 via Internet 1005. In some embodiments, such routing may employ Stealth technology developed by Unisys Corporation of Blue Bell, Pa., the assignee of the instant disclosure and described in more detail in U.S. patent application Ser. Nos. 12/346,578, 12/346,561, and 12/336,568, which are incorporated herein by reference in their entirety. In the illustrated embodiment, data previously stored in database 956 can be replicated to cloud database 1056. In some embodiments, database 956 may employ one or more quiesce copies, thereby facilitating more rapid replication to cloud database 1056. When replication is complete, database server 954 can begin addressing cloud database 1056 instead of database 956.

While the data is being replicated, cloud database server 1054 can be provisioned. Cloud database server 1054 may be provisioned as one or more real and/or virtual servers which facilitate access to cloud database server 1054. Such provisioning may include, without limitation, replication of any customizations stored on or made to database server 954. When cloud database server 1054 is ready to be brought online, inventory management server 953 can be instructed to direct any database-related requests to cloud database server 1054.

While cloud database server 1054 is being provisioned, cloud middleware server 1052 can also be provisioned. Cloud middleware server 1054 can comprise one or more real and/or virtual machines, and may be provisioned with any customizations stored on or made to inventory management middleware server 953. By way of example, without limitation, the middleware software that runs on inventory management server 953 may employ one or more templates, scripts, or other customizations, which are stored in one or more known directories on inventory management server 953. As part of the provisioning process, the contents of these directories may be replicated to cloud middleware server 1052, thereby allowing cloud middleware server 1052 to perform these same functions. When cloud middleware server 1052 has been properly provisioned, inventory management web server 952 can be instructed to utilize cloud middleware server 1052 in lieu of inventory management middleware server 953.

While cloud middleware server 1052 is being provisioned, cloud web server 1050 can also be provisioned. Cloud web server 1050 can comprise one or more real and/or virtual machines, and may be provisioned with any customizations stored on or made to inventory management web server 952. When cloud web server 952 has been properly provisioned, router 915 and/or router 935 can be instructed to route all inventory management related requests to cloud router 1040.

It should be noted that, although the provisioning is described above as occurring serially, the provisioning can occur in parallel without departing from the spirit or the scope of the disclosure.

Through the provisioning method described above, inventory management system 950 can be easily transitioned from within data center 930 to cloud resources 1000. As described above, this frees servers 952, 953, and 954, and database 956, to assist with increased demand for accounting system 960. In some embodiments, server 952 can be reprovisioned with a software configuration similar to that of accounting web server 962. Similarly, server 953 may be reprovisioned with a configuration similar to that of accounting middleware server 963, and server 954 may be reprovisioned with a software configuration similar to that of accounting database server 964. The data stored in accounting database 966 may also be replicated to database 956, and the databases may be linked to facilitate database consistency. When the reprovisioning is complete and access requests are received for the newly enhanced accounting system 960, router 935 may employ a round-robin scheme for routing the requests to one of accounting web servers 952 and 962. In other embodiments, router 935 or another such device may track utilization statistics, response times, or the like to determine the appropriate server to which the request should be routed. Such utilization statistics may be created by router 935, or provided by one or more of accounting web servers 952 and 962, and/or another device.

In some embodiments, the need for additional resources occurs on a periodic, predictable schedule and initiation of the migration from data center 930 to cloud resources 1000 can occur based on that schedule. By way of example, without limitation, if it is known that additional resources are needed every April 1, July 1, September 1, and January 1, the disclosed secure custom application cloud computing architecture can be scheduled to automatically initiate the migration process on March 31, June 30, August 31, and December 31, or the weekends preceding such dates, to further ease any transition-related issues. Where the need is likely to last a given time, automated deprovisioning, which employs a process similar to the provisioning process described above, can also be scheduled in advanced.

In other embodiments, the need for additional resources may occur dynamically, based on unforeseen issues. By way of example, without limitation, if accounting web server 962 were to fail, the instant architecture can dynamically migrate inventory management web server 952 to the cloud, thereby freeing server 952 to perform the functions previously performed by accounting web server 962. In some embodiments, when such a fail-over occurs, the entirety of inventory management system 950 is migrated to the cloud. The dynamic nature of the instant secure custom application cloud computing architecture thereby facilitates virtually seamless migration to and from the cloud on an as-needed basis, thereby allowing customers to gain access to the power and reliability of cloud computing while still enabling them to keep certain data and other information off of the cloud.

In some embodiments, the disclosed secure custom application cloud computing architecture can be used as a permanent location for a particular custom application. By way of example, without limitation, once the inventory management system has been migrated into the cloud, the hospital may determine that it does not need constant access thereto. The hospital can therefore request that the custom application be archived away for later use. In such an embodiment, any user data, customizations, custom applications, and the like can be stored on one or more storage media for later retrieval. Any virtual machines supporting the custom application can then be shut down, and any physical machines can be marked as available for repurposing. When the hospital wishes to use the inventory management system again, the hospital simply submits a provisioning request and the custom application, including the network architecture supporting the custom application, can be rebuilt by the instant architecture. In some embodiments, when the archived copy is created, the archive comprises a snapshot of the exact system configuration, including any information in buffers, the current login states of any users, or the like. In such an embodiment, when an archive is restored, all aspects of the system are also restored.

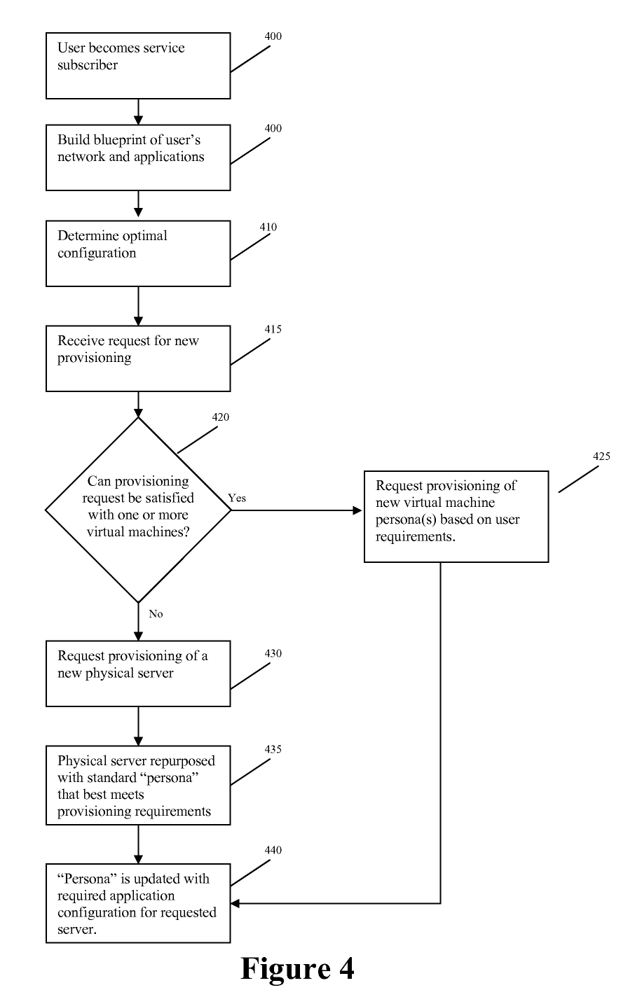

In some embodiments, access to the disclosed secure custom application cloud computing architecture is provided as a service. FIG. 4 is a flow chart illustrating an exemplary method by which a customer can enable the service, including provisioning of one or more servers in a secure custom application cloud computing architecture. In FIG. 4, the customer or user begins by subscribing to the service (Block 400). A model (“blueprint”) can then be created of the user's network (Block 405), including, without limitation, an enumeration of the various hardware and software resources which enable the network, including any customizations thereto, linked libraries and other files used thereby, and the like. In some embodiments, the blueprints can include listings of the directories or other locations in which any customization to the software is stored. The blueprints can also include detailed specifications about the various network components, including, without limitation, the number and speed of the processors in at least a subset of the computing devices that make up the network, the amount of memory available in each computing device, average response times to queries, the number of concurrent users supported, and the like.

An optimal cloud configuration is then determined (Block 410) based on the information in the blueprint. Such a cloud configuration may differ from the actual network configuration, in that some resources which are currently provided by physical servers may be provided by one or more virtual machines.

When the user is ready to initiate the migration of their software to the cloud, the user does so by issuing a provisioning request which is received by the instant architecture (Block 415). Such a provisioning request may comprise a blueprint, or a pointer to where the blueprint can be found. By way of example, without limitation, the blueprint may be stored in a database associated with the instant architecture, and the pointer can comprise a reference to the blueprint's location within the database.

The provisioning request is examined (block 420) to determine whether it can be completely satisfied with one or more virtual machines. If so, individual virtual machines are provisioned with appropriate “personas” (Block 425). Processing then continues to Block 440, described below. The personas are described in more detail below.

In the event one or more physical machines are required, the logic flow continues to block 430, in which the provisioning of the new physical server is requested. In some embodiments, one or more physical servers may be sitting idle in a data center serving the instant architecture or as part of the cloud computing environment, waiting for a provisioning request. In other embodiments, where such servers are not immediately available, the instant architecture may perform a consolidation analysis of the servers, or a subset of the servers, in the cloud or data center. An exemplary consolidation analysis is described in U.S. patent application Ser. No. 10/549,652, which is incorporated herein by reference in its entirety. Such a consolidation analysis can move the software and services currently running on a plurality of physical servers onto fewer physical servers, thereby freeing at least one physical server to meet the user's provisioning requests.

Once a suitable physical server has been identified, that physical server is repurposed with one of a plurality of standard “personas” (Block 435) that best meets the provisioning requirements. In some embodiments, the physical server may contain a plurality of processors and/or significant quantities of random access memory (“RAM”). As should be appreciated by one skilled in the art, such RAM can store instructions and/or data which is used by the processors. Such instructions can cause the processor to execute a series of steps that bring about a desired goal, such as performing the accounting tasks described above.

In some embodiments, the persona chosen in response to the provisioning request can enable and/or disable access to one or more of the processors and/or a portion of the RAM, thereby altering the performance characteristics of the physical server. Similarly, the persona may specify a specific operating system and default software that is configured therein. When the physical server has been repurposed, or the virtual server created, with the appropriate persona (Block 440), the server's configuration is compared against the provisioning request and/or the blueprint to determine any additional software, or customizations thereto, that should be loaded onto the server.

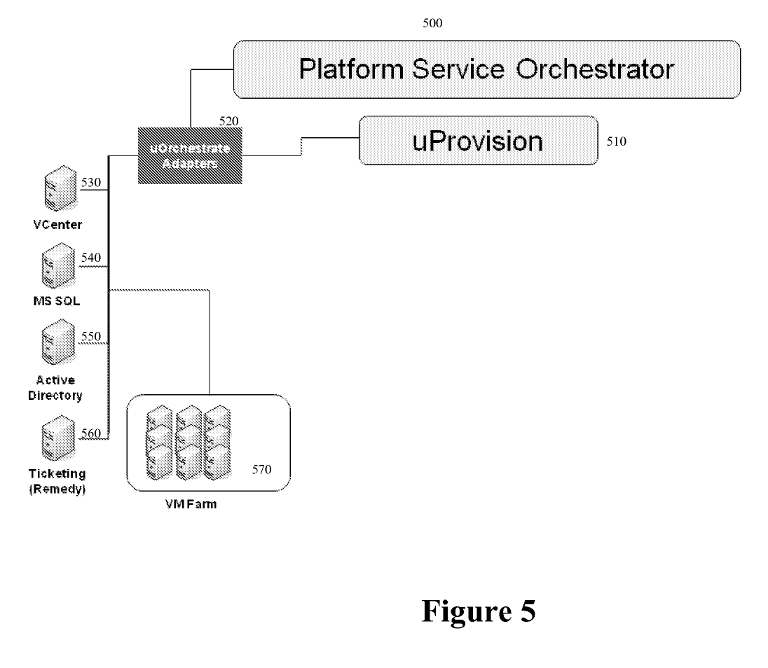

The above-described provisioning method is illustrated in FIGS. 5-8. FIG. 5 is a block diagram illustrating an exemplary secure custom application cloud computing architecture prior to the receipt of a provisioning request. In FIG. 5, platform service orchestrator 500 is responsible for managing the operation of the architecture and for receiving provisioning requests from users. uProvision 510 is a back-end service which tracks the various physical and virtual servers employed within the architecture. uOrchestrate Adapters 520 automates the application of business rules (including, without limitation, the instantiation of accounting and other procedures) to the provisioning requests, and to the operation of the architecture in general. By way of example, without limitation, uOrchestrate Adapters 520 may instantiate a monitor which tracks performance of a provisioned server. Such performance information may include, without limitation, the peak and average number of users concurrently being served by the server, the number of queries received by the provisioned server, the number of instructions executed by the server per monitored time period, the amount of memory and/or storage space used by the provisioned server, and the like. Such performance information can then be used for billing purposes. By way of example, without limitation, the user may be billed on a per-million-instruction per second basis, based on the average amount of storage space used, or the like.

In addition to software and services that manage the architecture, some embodiments of the architecture may also include one or more dedicated servers for providing specific functionality to the architecture. By way of example, without limitation, FIG. 5 includes MsSql Server 540, which is a database server which facilitates storage of the information used by the various components of the architecture. Although described herein as employing a version of SQL server distributed by Microsoft Corporation of Redmond, Wash., one skilled in the art should appreciated that alternative databases can be substituted therefor without departing from the spirit or the scope of the disclosure.

Active Directory 550 is a server which manages the user accounts and related information associated with the maintenance of the architecture. Active Directory is a technology associated with Windows Server, an operating system developed and distributed by Microsoft Corporation. Although the instant architecture is described as employing Active Directory, one skilled in the art should appreciate that alternative directory and/or user account schemas, such as, without limitation, X.500, can be employed without departing from the spirit or the scope of the disclosure.

Ticketing 560 is a server which is responsible for managing the implementation of specific provisioning requests. VM Farm 570 is a plurality of virtual machines that are running on one or more physical servers. VCenter 530 is a server which facilitates control over the various virtual machines running in the architecture.

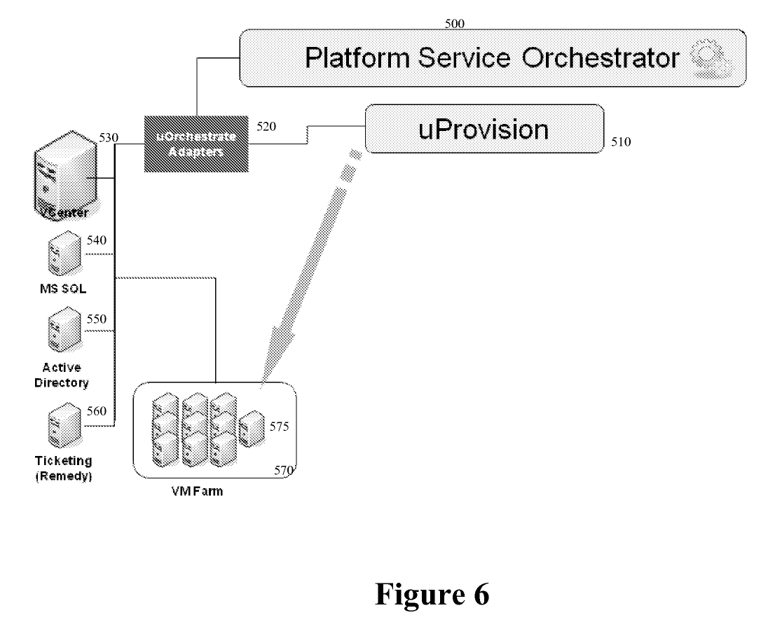

In FIG. 6, a new provisioning request is received, the provisioning request comprising a request for a server that can be implemented as a virtual server. In such an embodiment, platform service orchestrator 500 alerts uOrchestrate adapters 520 of the new provisioning request, and uProvision 510 is alerted that a new virtual machine is to be created. uProvision 510 sends a provisioning request to Ticketing 560, which in turn instantiates the virtual machine within VM farm 570. The virtual machine is added to the list of machines maintained by VCenter 530.

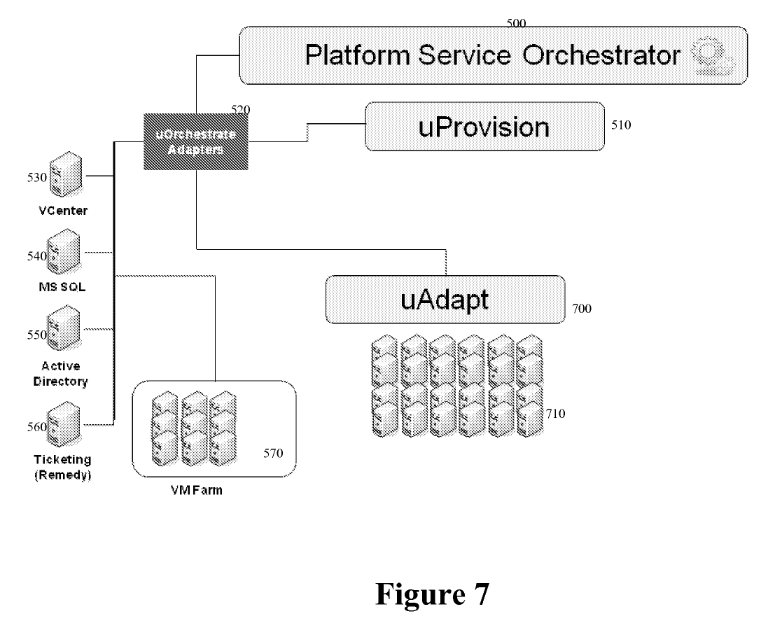

In FIG. 7, a new provisioning request is received, the provisioning request comprising a request that cannot be implemented as a virtual server. In such an embodiment, platform service orchestrator 500 alerts uOrchestrate adapters 520 of the new provisioning request, and uProvision 510 is alerted that a physical machine is to be provisioned. uOrchestrate adapters 520 communicates the provisioning request to uAdapt 700, which manages the physical servers associated with the architecture. uAdapt 700 identifies a physical server 710 that is to be used to meet the provisioning request. As described above, such a physical server may be an existing server that is repurposed to meet the provisioning request, or an idle server that is appropriately provisioned.

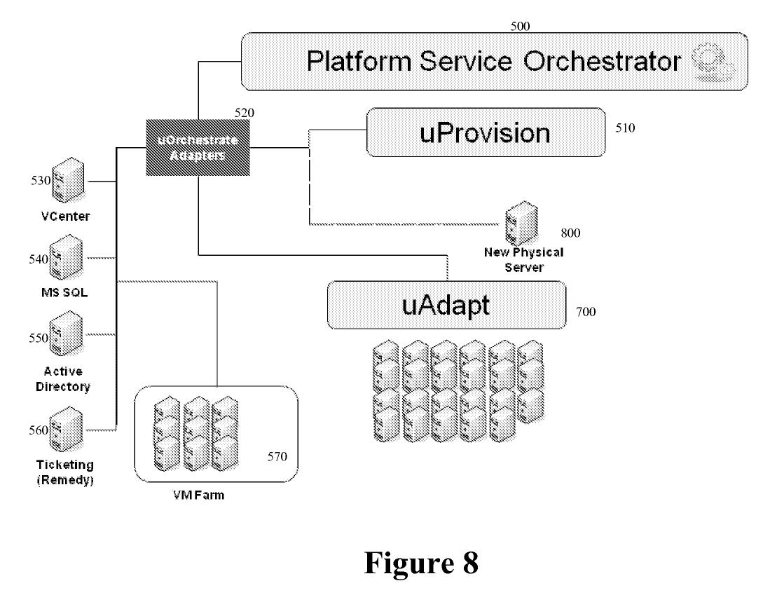

As illustrated in FIG. 8, in some embodiments uAdapt 700 transfers control of physical server 710 to uProvision 510, the physical server being redesignated as new physical server 800 in FIG. 8. uProvision 510 specifies the persona to be implemented on new physical server 800, and causes the appropriate software, including any customizations, to be loaded thereon. Control of new physical server 800 is then passed back to uAdapt 700, and the user is notified that the server is available.

As should be appreciated by one skilled in the art, the creation of a blueprint of the user's network allows the instant secure custom application cloud computing architecture to dynamically replicate a single server or an entire n-tier architecture in the cloud. Combined with the ability to rapidly migrate custom software from a user's network to the cloud, the instant secure custom application cloud computing architecture obviates many of the obstacles previously preventing users from leveraging cloud computing. It should also be appreciated that certain aspects of the instant secure custom application cloud computing architecture can be implemented as hardware, software, firmware, and/or combinations thereof. Such software can be tangibly stored on one or more computer readable media, such as, without limitation, a disc, floppy, flash, thumb, or solid state drive, a Compact Disc (“CD”), a digital versatile disc (“DVD”), or electronically programmable read only memory (“EPROM”). The software can include instructions which, when executed by the processor, cause the processor to perform certain functions.

While detailed and specific embodiments of the secure custom application cloud computing architecture have been described herein, it will be apparent to those skilled in the art that various changes and modifications can be made therein without departing from the spirit and scope of the secure custom application cloud computing architecture. Thus, it is intended that the present disclosure cover these modifications and variations provided they come within the scope of any appended claims and/or their equivalents.

What is claimed is:

1. A method comprising:
receiving a request to subscribe to a service whereby a custom application can be migrated from a private computing environment to a cloud computing environment;
creating a model of the custom application;
evaluating the model and determining an optimal configuration that can be supported by the cloud computing environment;
receiving a provisioning request;
instantiating at least one physical or virtual machine to facilitate migration of the custom application to the cloud computing environment; and,
migrating the custom application to the cloud computing environment.

2. The method of claim 1, the model comprising a detailed listing of the computing resources used to support the custom application.

3. The method of claim 2, the computing resources comprising a definition of the network architecture used to support the custom application.

4. The method of claim 3, the network architecture comprising at least one of the computing capabilities of at least a subset of the components of the network architecture.

5. The method of claim 2, the computing resources comprising a definition of the linked libraries and customizations used by the custom application.

6. The method of claim 2, further comprising:
deprovisioning the computing resources used to support the custom application; and,
repurposing the deprovisioned computing resources to support another application in the private computing environment.

7. The method of claim 6, further comprising:
deprovisioning the repurposed computing resources;
reprovisioning the deprovisioned computing resources to support the custom application; and,
migrating the custom application from the cloud computing environment back to the reprovisioned computing equipment in the private computing environment.

8. The method of claim 2, further comprising:
receiving a request to archive the custom application;
archiving at least a portion of the computing resources associated with the custom application in the cloud computing environment; and,
deprovisioning the computing resources in the cloud environment that were associated with the custom application.

9. The method of claim 9, the deprovisioning comprising shutting down of any virtual servers associated with the custom application.

10. The method of claim 9, the deprovisioning comprising marking as available for reprovisioning any physical servers associated with the custom application.

11. A secure custom application cloud computing architecture comprising:
a platform service orchestrator, the platform service orchestrator managing the operation of the architecture and for receiving a provisioning request;
a provisioning service, the provisioning service tracking and managing various physical and virtual servers employed within the architecture;
at least one adapter, the at least one adapter automating the application of business rules to received provisioning requests;
a plurality of physical machines, at least one of the physical machines being repurposed with a persona selected by the provisioning service based on the received provisioning request; and,
at least one virtual machine farm, the virtual machine farm facilitating the running on at least one virtual machine based on the received provisioning request.

12. The architecture of claim 11, the provisioning request comprising a request from a user.

13. The architecture of claim 11, the provisioning request comprising at least one of a pointer to a blueprint of an architecture for supporting a custom application or the blueprint itself.

14. The architecture of claim 13, the architecture comprising an n-tier architecture for supporting the operation of the custom application.

15. The architecture of claim 13, the blueprint further comprising information necessary to deploy the custom application within the custom application cloud computing architecture.

16. The architecture of claim 11, the platform service orchestrator receiving the provisioning request and, in response thereto, instructing the provisioning service to provision at least one of a physical server and a virtual server.

17. The architecture of claim 16, the at least one adapter instantiating a monitor which tracks performance of the provisioned server.

18. The architecture of claim 17, the performance being used as a basis for billing a user.

19. The architecture of claim 18, the tracked performance comprising the number of instructions executed by the provisioned server in a period of time.

20. The architecture of claim 18, the tracked performance comprising the average amount of storage space used by the provisioned server in a period of time.
